(19) United States
(12) Patent Application Publication
(10) Pub. No.: US 2007/0210134 A1
(43) Pub. Date: Sep. 13, 2007

(54) PORTABLE DRIVER

(76) Inventors: Hiroyuki ODA, Ibaraki (JP); Takashi UEDA, Ibaraki (JP); Yoshihiro NAKANO, Ibaraki (JP); Hideyuki TANIMOTO, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/683,574

(22) Filed: Mar. 8, 2007

(30) Foreign Application Priority Data
Mar. 9, 2006 (JP) P2006-064286

(51) Int. Cl. B25C 5/02

(52) U.S. Cl. 227/131

(57) ABSTRACT

In a portable driver (portable driver) comprising: a driver plate 18B for driving a nail (fastener); a plunger 18 formed integrally to or separately from the driver plate 18B; a rack 18A formed on the plunger 18; a pinion to be tooth-engaged with the rack 18A; and a driving means for rotatively driving the pinion, in which the fastener is driven by linearly moving the plunger 18 and the driver plate 18B owing to rotation of the pinion, a tooth width of the rack 18A is changed in a longitudinal direction thereof. For example, the tooth width L1 in an area A of the rack with which the pinion is tooth-engaged when driving is started or being carried out is set to be narrower than the tooth width L2 in an area B of the rack with which the pinion is tooth-engaged when the driving is completed, i.e. L1<L2.

### BACKGROUND

1. Technical Field

This invention relates to a portable driver for driving a fastener by linearly moving a plunger in a direction of driving the fastener.

2. Description of Related-Art

Such a kind of previously known portable driver includes a driver plate for driving a fastener; a plunger formed integrally to or separately from the driver plate; a rack formed on the plunger; a pinion tooth-engaged with the rack; and a driving means for rotatively driving the pinion (Patent Reference 1). This portable driver drives the fastener such as a nail by rotatively driving the pinion through a driving means to linearly move the plunger and the driver plate.

Meanwhile, in such a portable driver, the lighter the plunger is, the faster it is accelerated so that the driving time can be shortened. If the driving time is short, the energy loss due to friction in driving can be restrained so that the energy efficiency is enhanced. Further, the lighter the plunger is, the smaller is the repulsive force from which the driver body suffers in accelerating the plunger. This restrains the reaction thereof at the time of driving, thus improving the workability.

Further, after the nail has been driven, the plunger violently collides with a damper so that shock is absorbed. In this case, if the plunger is light, the kinetic energy accumulated in the plunger itself is also small. Thus, the energy to be absorbed by the damper when the plunger violently collides may be small. Accordingly, the volume of the damper can be reduced so that it is downsized.

[Patent Reference 1] JP-A-63-057180

### SUMMARY

Meanwhile, in the portable driver, nearly when the driving is completed, the largest force acts on the rack of the plunger with which the pinion is tooth-engaged; and when the driving is started or being carried out, large force does not act. Thus, from the standpoint of rationally designing the plunger, the tooth width of the rack should be set at a value capable of assuring strength necessary for the force acting on the pertinent area.

However, in a conventional portable driver, the tooth width of the rack is constant in the longitudinal direction thereof and set at such a value that even if the greatest force acts on when the driving is completed, sufficient strength can be assured. Thus, the tooth width in the area of the rack on which great force does not act is excessively large. As a result, it is not possible to enhance the energy efficiency at the time of driving by reducing the weight of the plunger and restrain the reaction.

In view of the above circumstances, this invention has been accomplished. An object of this invention is to provide a portable driver capable of enhancing energy efficiency at the time of driving and restraining reaction at the time of driving.

In order to attain the above object, the invention described in claim 1 is a portable driver comprising: a driver plate for driving a fastener; a plunger formed integrally to or separately from the driver plate; a rack formed on the plunger; a pinion to be tooth-engaged with the rack; and a driving means for rotatively driving the pinion, wherein the fastener is driven by linearly moving the plunger and the driver plate owing to rotation of the pinion, characterized in that a tooth width of the rack is changed in a longitudinal direction thereof.

The invention described in claim 2 is a portable driver according to claim 1, characterized in that the tooth width of the rack is changed in at least two steps.

The invention described in claim 3 is a portable driver according to claim 1 or 2, characterized in that the tooth width L1 in an area A of the rack with which the pinion is tooth-engaged when driving is started or being carried out is narrower than the tooth width L2 in an area B of the rack with which the pinion is tooth-engaged when the driving is completed, i.e. L1<L2.

The invention described in claim 4 is a portable driver according to any one of claims 1 to 3, characterized in that groove-like reduced thickness zones are formed on both sides of the plunger.

In the inventions according to claims 1 and 2, the tooth width of the rack can be determined according to the force acting on the rack. More concretely, as in the invention described in claim 3, if the tooth width L1 in an area A of the rack (smaller force acts on than the force when the driving is completed) with which the pinion is tooth-engaged when driving is started or being carried out is set to be narrower than tooth width L2 in an area B of the rack (greater force acts on) with which the pinion is tooth-engaged when the driving is completed, i.e. L1<L2, the tooth width of the rack can be set at an appropriate value according to the force acting on the pertinent area of the rack. Therefore, according to the degree of reducing the tooth width in the area A of the rack, the plunger can be weight-reduced.

In this way, if the plunger is weight-reduced, since the plunger can be accelerated faster, the driving time can be shortened. If the driving time is short, the energy loss due to friction in driving can be restrained so that the energy efficiency is enhanced.

Further, the lighter the plunger is, the smaller is the repulsive force from which the driver body suffers in accelerating the plunger. This restrains the reaction thereof at the time of driving, thus improving the workability.

Further, if the plunger is light, the kinetic energy accumulated in the plunger itself is also small. Thus, the volume of the damper for absorbing energy when the plunger violently collides at the time of driving can be reduced so that it is downsized.

In accordance with the invention described in claim 4, by the groove-like reduced thickness zones formed on both sides of the plunger, the plunger can be further weight-reduced.

### BRIEF DESCRIPTION OF THE DRAWINGS

FIG. 1 is a side sectional view of the electric nail driver (portable driver) according to this invention.

FIG. 2 is an enlarged sectional view taken in line A-A in FIG. 1.

FIG. 3 is a front view of a plunger and a driver plate of the electric nail driver according to this invention.

FIG. 4 is a broken side view of the plunger and the driver plate of the electric nail driver according to this invention.

FIG. 5 is aplanar sectional view of a driving unit (clutch OFF-state) of the electric nail driver according to this invention.

FIG. 6 is a sectional view taken in line B-B in FIG. 5.

FIG. 7 is aplanar sectional view of a driving unit (clutch ON-state) of the electric nail driver according to this invention.

FIG. 8 is a sectional view taken in line C-C in FIG. 7.

FIG. 9 is a side view of a coil spring of the electric nail driver according to this invention.

FIG. 10 is a front view of the coil spring of the electric nail driver according to this invention.

FIG. 11 is a broken side view of a flange of the electric nail driver according to this invention.

FIG. 12 is a broken side view of the coil spring inserted in the flange of the electric nail driver according to this invention.

FIG. 13 is a view for explaining the operation when the driving is started in the electric nail driver according to this invention.

FIG. 14 is a view for explaining the operation when the driving is completed in the electric nail driver according to this invention.

FIG. 15(a) is a front view of the plunger and the driver plate in a modification of the electric nail driver according to this invention; and FIG. 15(b) is a broken side view of the plunger and the driver plate in the modification of the electric nail driver according to this invention.

FIG. 16(a) is a front view of a plunger and a driver plate according to a modification of the electric nail driver according to this invention; FIG. 16(b) is a broken side view of the plunger and the driver plate thereof; and FIG. 16(c) is a sectional view taken in line D-D in FIG. 16(b).

### DESCRIPTION OF THE EMBODIMENTS

Now referring to the attached drawings, an explanation will be given of an embodiment of this invention using, as an example, an electric nail driver which is a form of the portable driver.

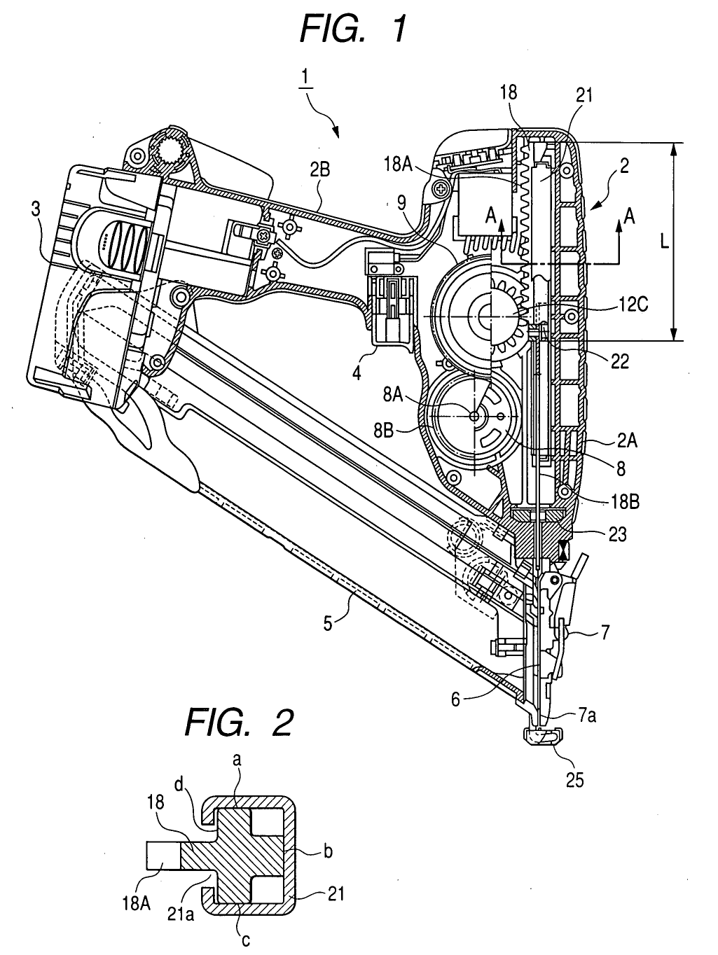

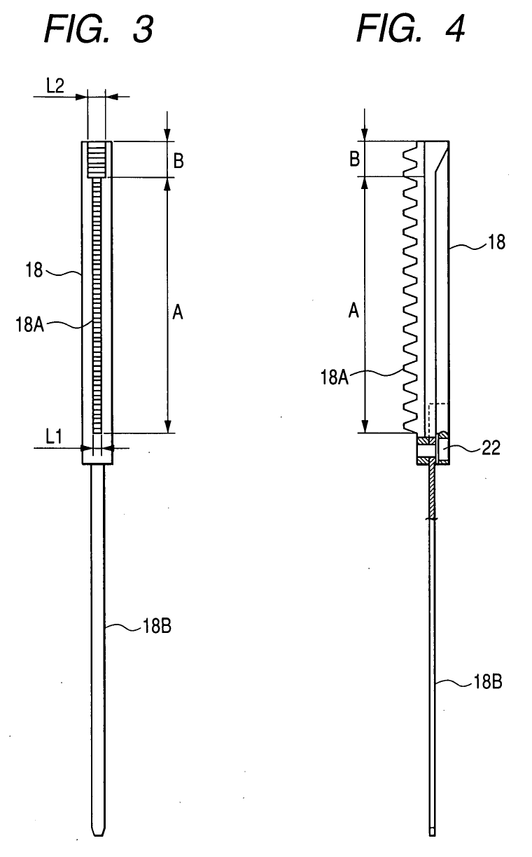

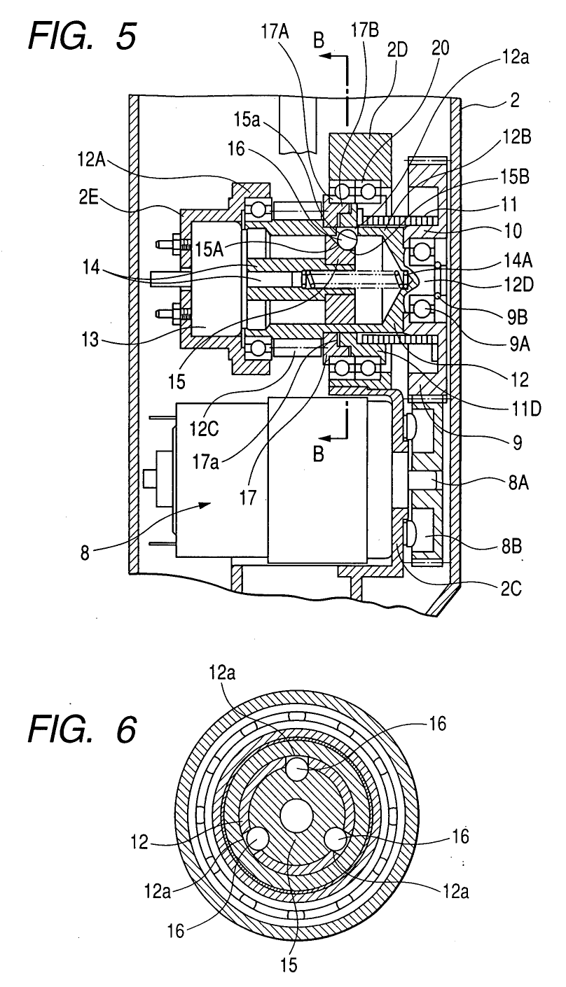

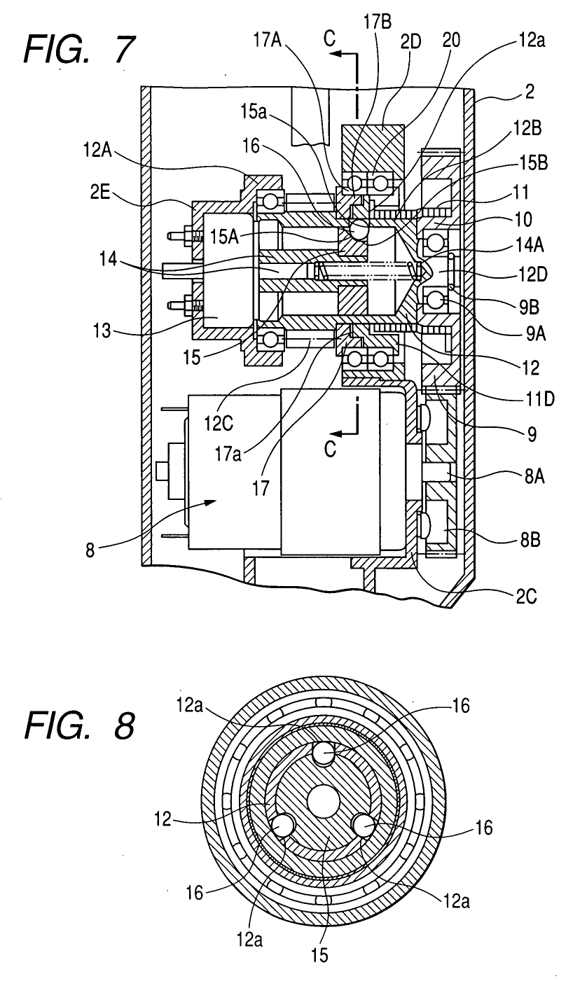

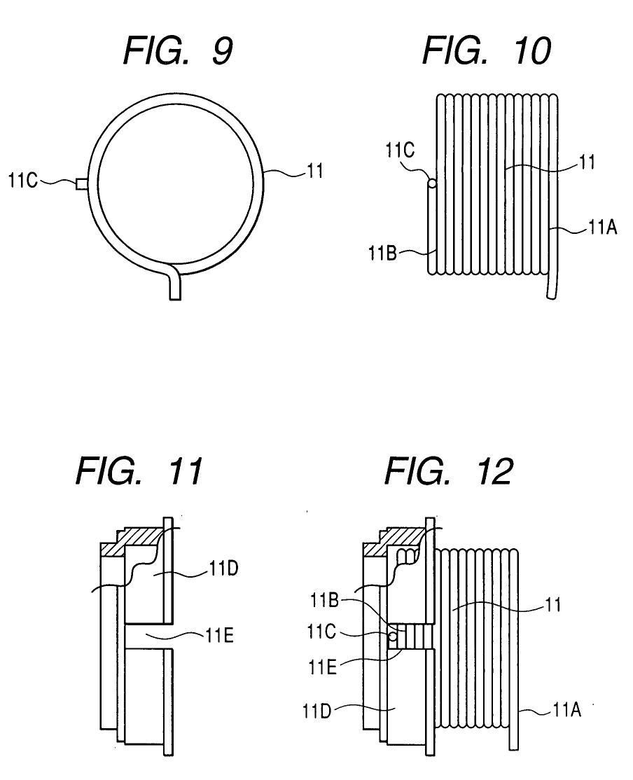

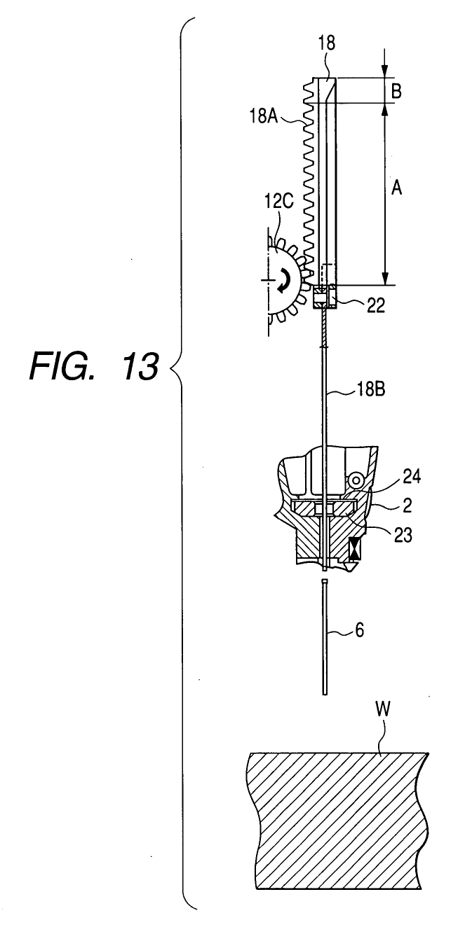

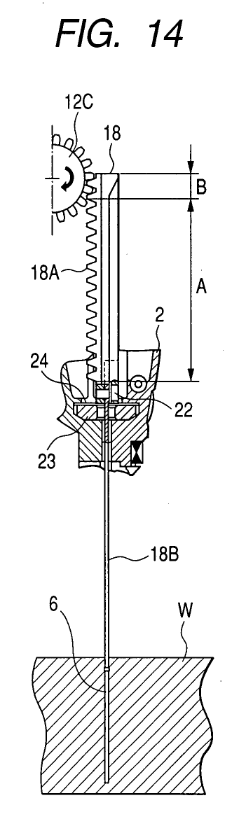

FIG. 1 is a side sectional view of the electric nail driver (portable driver) according to this invention. FIG. 2 is an enlarged sectional view taken in line A-A in FIG. 1. FIG. 3 is a front view of a plunger and a driver plate. FIG. 4 is a broken side view of the plunger and the driver plate. FIG. 5 is a planar sectional view of a driving unit (clutch OFF-state) of the electric nail driver. FIG. 6 is a sectional view taken in line B-B in FIG. 5. FIG. 7 is a planar sectional view of a driving unit (clutch ON-state) of the electric nail driver. FIG. 8 is a sectional view taken in line C-C in FIG. 7. FIG. 9 is a side view of a coil spring. FIG. 10 is a front view of the coil spring. FIG. 11 is a broken side view of a flange. FIG. 12 is a broken side view of the coil spring inserted in the flange. FIG. 13 is a view for explaining the operation when the driving is started. FIG. 14 is a view for explaining the operation when the driving is completed.

In an electric nail driver 1 shown in FIG. 1, reference numeral 2 denotes a resin housing which is a cover member. The housing 2 is composed of a cylindrical body 2A and a handle 2B connected to the body 2A in a T-shape when viewed from side. At the terminal of the handle 2B of the housing 2 (at the free end opposite to the body 2A), provided is a battery pack 3 for incorporating a battery not shown serving as a power source. In an area of the handle 2B of the housing 2 near to the body 2A thereof, a trigger switch 4 is provided.

Further, as shown in FIG. 1, at the lower end of the housing 2, an injector 7 is provided. To the injector 7, a flat square box-shaped magazine 5 is attached aslant to the body 2A when viewed from side. More concretely, the one end of the magazine 5 is attached to the injector 7 (lower end in FIG. 1) attached to the tip of the body 2A of the housing 2 whereas the other end thereof is attached to the vicinity of the batterypack 3 at the terminal of the handle 2B of the housing 2. In the state shown in FIG. 1, the magazine 5 is inclined aslant upward from the injector 7 attached to the tip of the body 2A of the housing 2 toward the terminal of the handle 2B. Incidentally, although not shown, the magazine 5 incorporates a large number of nails 6 connected stepwise.

Now referring to FIGS. 1 and 5, an explanation will be given of the internal structure of the housing 2.

A motor 8 serving as a driving source is housed in landscape orientation within the body 2A of the housing 2. A gear 8B is fixed to the end of an output shaft (motor shaft) 8A extending from the motor 8 in a direction (direction perpendicular to the paper face in FIG. 1) of the rotating center of the motor 8.

Aside the motor 8 within the body 2A of the housing 2, as seen from FIG. 5, a rotatable driven shaft 12 is arranged in parallel to the output shaft 8A of the motor 8. On the driven shaft 12, a pinion 12C is formed and a flywheel 9 is rotatably supported. The flywheel 9 is tooth-engaged with the gear 8B.

Further, as seen from FIG. 1, within the body 2A of the housing 2, a plunger 18 to be tooth-engaged with the pinion 12C is housed reciprocally linearly movably in a vertical direction in FIG. 1 along a linear rail 21 serving as a guiding means. At the tip (lower end in FIG. 1) of the plunger 18, a driver plate 18B for extruding a nail 6 is attached by a bolt 22. It should be noted that the plunger 18 is urged in a direction returning to the initial position by a return spring not shown. Further, in this embodiment, the driver plate 18B is formed as a member separated from the plunger 18B and attached to the plunger 18 by the bolt 22. However, the driver plate 18B may be formed integrally to the plunger 18.

Now, the rail 21 covers a part of the plunger 18 and serves as a guiding means for guiding the reciprocal linear movement of the plunger 18. The rail 21, as shown in FIG. 2, is formed of a hollow member in a square pipe shape. At a part of the rail 21 (left end face in FIG. 2 opposite to the pinion 12C), a slit (opening) 21a is formed over the entire length along the moving direction (vertical direction in FIG. 1) of the plunger 18. Therefore, the rail 21 has a shape which completely covers face a, face b and face c of the plunger 18, and partially covers face d except a rack 18A (see FIG. 2).

As described above, in this embodiment, the rail 21 is formed of a hollow member in a square pipe shape and the slit 21a is formed over the entire length thereof. For this reason, the rail 21 can be manufactured by bending a plate-like member. For example, the rail 21 can be manufactured easily and at low cost by e.g. press working of a metallic plate using a stamping die.

Thus, as shown in FIG. 2, the plunger 18 is fit in the rail 21 with a slight gap therebetween so that its reciprocal linear movement is guided by the rail 21. The plunger 18 is preferably fit in and held by the rail 21 having a length more than 50% of the entire length thereof. The portion opposite to the pinion 12C of the plunger 18, as seen from FIG. 2, outwardly protrudes from the slit (opening) 21a of the rail 21. In the protruding portion, as shown in FIG. 1, the rack 18A is formed. The pinion 12c is tooth-engaged with the rack 18A.

Further, as shown in FIG. 1, within the body 2A of the housing 2, a damper 23 is arranged with which the plunger 18 violently collides when the driving is completed as shown in FIG. 14. Now, the damper 23 is formed of an elastic material such as rubber in a ring shape and serves to absorb the shock due to the violent collision of the plunger 18. Incidentally, in FIGS. 13 and 14, reference numeral 24 denotes a damper plate for holding the damper 23.

Meanwhile, this embodiment is characterized in that the tooth width of the rack 18A formed on the plunger 18 is changed by at least two steps in a longitudinal direction thereof. More concretely, this embodiment is characterized in that the tooth width L1 in an area A of the rack 18A with which the pinion 12C is tooth-engaged when driving is started (see FIG. 13) or being carried out is narrower than the tooth width L2 in an area B of the rack 18A with which the pinion 12C is tooth-engaged when the driving is completed as shown in FIG. 14, i.e. L1<L2 (see FIG. 3).

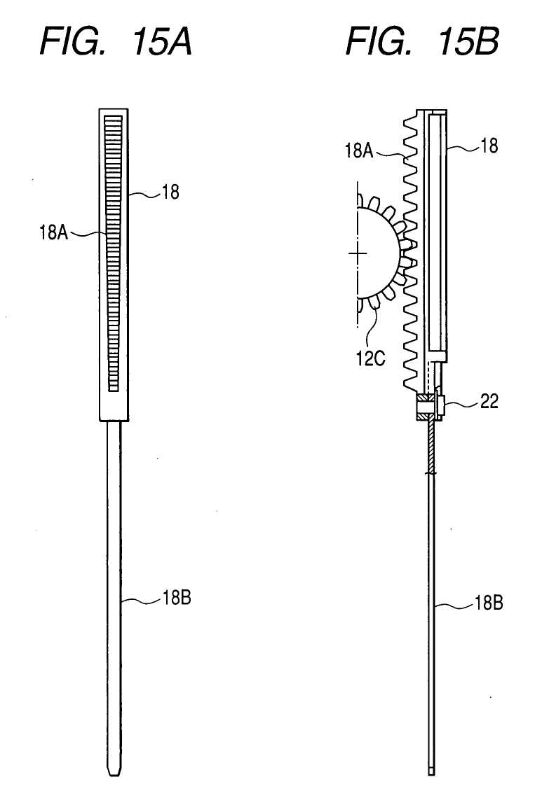

The area B of the rack 18A is an area suffering great shocking reaction from the pinion 12C. Therefore, the tooth width L2 of this area B is set at a value enough to assure the strength capable of enduring great shocking reaction. On the other hand, the area A of the rack 18A is an area with which the pinion 12C is tooth-engaged when driving is started or being carried out. The force acting on the area A is smaller than that acting on the area B. Therefore, the tooth width L1 in the area A of the rack 18A has only to assure the strength enough to endure relatively small force. Thus, in this embodiment, the tooth width L1 in the area A of the rack 18A is set to be smaller than the tooth width L2 in the area B of the rack 18A (L1<L2). In short, in this embodiment, the tooth width of the rack 18A is set according to the magnitude of the force acting on the pertinent area. In this embodiment, although the tooth width of the rack 18A was changed in two steps in a longitudinal direction thereof, the tooth width of the rack 18A may be changed in three or more steps. Further, as shown in FIG. 15(a), (b), the tooth width of the rack 18A may be changed continuously in the longitudinal direction. Incidentally, FIG. 15(a) is a front view of the plunger 18 and the driver plate 18B; and FIG. 15(b) is a broken side view of the plunger 18 and the driver plate 18B.

Meanwhile, between the flywheel 9 and the driven shaft 12, a clutch mechanism for selectively turning ON/OFF the connection therebetween is provided. Referring to FIGS. 5 to 12, an explanation will be given of the configuration of the clutch mechanism.

As shown in FIG. 5, on the wall 2D of the housing 2, a driven shaft 12 is rotatably supported through a bearing 17A. The driven shaft 12 which is formed in a cylindrical shape is also supported by the wall 2E of the housing 2 through a bearing 12A. In this way, the driven shaft 12 is supported at two points. For this reason, even if force is abruptly applied to the driven shaft 12, it can be rotated stably. Further, the pinion 12C is formed in the region between the bearing 12A in the outer periphery of driven shaft 12 and the bearing 17A. Incidentally, the wall 2E also supports a solenoid 13 described later.

Further, as shown in FIG. 5, a nearly-circular driven shaft support 17 is fit in the driven shaft 12. The driven shaft 12 is supported by the bearing 17A through the driven shaft support 17. The driven shaft support 17 has an extend-out segment 17B extending out in the axial direction. With the driven shaft support 17 being fit in the driven shaft 12, a groove 17a is formed between the extend-out segment 17B and the driven shaft 12.

A portion of a flange 11D described later is inserted in the groove 17a between the driven shaft 12 and the extend-out segment 17B. At the positions of the inserted portion opposite to the flange 11D, three slots 12a are made so as to pass through the inside and outside of the driven shaft 12 (see FIG. 6). In each of the slots 12a, a ball 16 is provided movably in the radial direction. Thus, the movement of the ball 16 is limited in the expansion/contraction direction of a solenoid driver 14 described later and in the circumferential direction of the driven shaft 12 whereas only the movement thereof in the radial direction of the driven shaft 12 is permitted.

In the region on the one end side of the driven shaft 12 and encircled by the wall 2E, a solenoid 13 is arranged. From the solenoid 13, the solenoid driver 14 extends out toward the space within the driven shaft 12. When a current is supplied to the solenoid 13, the solenoid driver 14 extends. In the expansion/contraction direction of the solenoid driver 14 in the space within the driven shaft 12, between the end of the solenoid driver 14 and the driven shaft 12, a solenoid twisting spring 14A is arranged in a contracted state. The solenoid twisting spring 14A urges the solenoid driver 14 in a contraction direction.

Further, at the end of the solenoid driver 14, a cylindrical column-shape urging member 15 is provided. The urging member 15 is rotatable about the axis of the cylindrical column shape. On the outer periphery of the urging member 15, a groove extending in the axial direction is formed. In this groove, a pressing segment 15A having a slope serving as a first urging face and a receiving segment 15B are provided. The slope of the pressing member 15A leaves the center as it approaches the solenoid 13. It should be noted that the outermost diameter of the urging member 15 is set to be slightly smaller than the inner diameter of the space within the driven shaft 12.

Between the pressing segment 15A and receiving segment 15B and the inner face of the internal space of the driven shaft 12, a gap 15a is formed. The receiving segment 15B is formed so that in this gap 15a, the sum of the distance from the receiving segment 15B surface to the inner face of the internal space of the driven shaft 12 and the thickness in the vicinity of the slot 12a of the driven shaft 12 is approximately equal to the diameter of the ball 16.

The movement quantity of the solenoid driver 14 is adjusted so that the receiving segment 15B surface is located at a position opposite to the slot 12a in the most contracted state of the solenoid driver 14 (power interrupting position) and the pressing segment 15A is located at a position opposite to the slot 12a in the most expanded position) of the solenoid driver 14 (power connecting position). Therefore, in the contracted state of the solenoid driver 14, the ball 16 is in contact with the surface of the receiving segment 15B. In this state, the ball 16 does not partially project from the outer surface of the driven shaft 12 via the slot 12a (see FIGS. 5 and 6).

Further, in the expanded state of the solenoid driver 14, the ball 16 is in contact with the pressing segment 15A (see FIG. 8). In this state, a part of the ball 16 partially projects from the outer surface of the driven shaft 12 (see FIGS. 7 and 8). According to the inclination of the body of the electric nail driver 1, the ball 16 may project from the slot 12a owing to gravitation. However, since the ball 16 is not supported by the pressing segment 15A, only slight urging force exists so that the flange 11D described later will not be urged.

Further, as shown in FIG. 5, on the other end side of the driven shaft 12 with respect to the slot 12a, a spring seat 12B is formed. At the tip of the spring seat 12B in parallel to the gear 18B in the longitudinal direction thereof, a supporting shaft 12D is provided. The flywheel 9 is rotatably attached to the supporting shaft 12D through the bearing 9A.

Now, the driven shaft 12 is rotatably supported on the walls 2D and 2E which are a part of the housing 2. Therefore, the flywheel 9 rotatably attached to the supporting shaft 12D which is a part of the driven shaft 12 through the bearing 9A is freely rotatable for the driven shaft 12 and is rotatably supported by the housing 2. Incidentally, at the end of the supporting shaft 12D, a stop ring 9B is attached for preventing the bearing 9A from being removed.

On the outer surface of the flywheel 9, a tooth segment is formed. The tooth segment is tooth-engaged with the gear 8B. Thus, when the gear 8B rotates clockwise, the flywheel 9 rotates counterclockwise. At the position coaxial with the driven shaft 12 of the flywheel 9, a drive shaft 10 is formed integrally thereto.

As seen from FIGS. 9 to 12, at the other end 11B of the coil spring 11, a flange 11D is provided. The flange 11D is a circular member and has a recess 11E at a part of the circle. As regards the flange 11D and the coil spring 11, the other end 11B of the coil spring 11 is coaxially inserted into the flange 11D and a projection 11C which is a tip of a steel wire on the other end 11B of the coil spring 11 is inserted into the recess 11E. For this reason, the flange 11D and the coil spring 11 can be integrally rotated in a rotating direction of the coil spring 11.

As shown in FIG. 5, the one end 11A of the coil spring 11 is secured to the drive shaft 10 and the spring seat 12B of the driven shaft 12 is inserted in the coil spring 11. Further, a bearing 20 is arranged adjacently to and in parallel to the bearing 17A. The flange 11D provided at the other end 11B of the coil spring 11 is rotatably supported by the bearing 20.

Now, it is assumed that when the coil spring 11 is a free state, the internal diameter of the coil spring 11 is approximately equal to the maximum outer diameter of the drive shaft 10 of the flywheel 9. Further, since the outer diameter of the spring seat 12B of the driven shaft 12 is smaller than the maximum outer diameter of the drive shaft 10, in a state where a current is not supplied to the motor 8, the coil spring 11 and driven shaft 12 are in a non-coupled state.

As seen from FIG. 6, where the ball 16 inserted in the slot 12a formed on the driven shaft 12 does not project from the surface of the spring seat 12B, the flange 11D can freely rotate in the groove 17a.

Next, an explanation will be given of the operation of the electric nail driver 1 configured as described above.

While an operator grasps the handle 2B of the housing 2, when he pulls the trigger switch 4 so that it is turned ON, the motor 8 is driven by the power source from the battery accommodated in the battery pack 3. Then, the rotation of the output shaft 8A of the motor 8 is transmitted from the gear 8B to the flywheel 9. Thus, the flywheel 9, its drive shaft 10 and coil spring 11 are rotated at a predetermined speed. When the flywheel 9 is rotated, its angular speed increases so that the rotating energy is accumulated in the flywheel 9. At this time, as seen from FIG. 5, the coil spring 11 is separated from the driven shaft 12 so that the driven shaft 12 does not rotate. Therefore, in this state, no abrasion is generated between the coil spring 11 and the driven shaft 12.

When a predetermined time elapses after the motor 8 starts to rotate, rotating energy necessary to drive the nail 6 is accumulated in the flywheel 9. Where a push-lever 25 has been pressed on a driven target W, the driver circuit not shown is actuated so that the solenoid 13 is energized. Thus, the solenoid driver 14 extends against the urging force of the solenoid twisting spring 14A. At this time, within the gap 15a, the face of the ball 16 in contact with the urging member 15 changes from the receiving segment 15B surface to the pressing segment 15A. The pressing segment 15A is formed of the slope and the ball 16 cannot move in the extension/contraction direction of the solenoid driver 14. Therefore, when the solenoid driver 14 extends, by the pressing segment 15A, the ball 16 is moved outwardly in the radial direction of the driven shaft 12. Thus, as seen from FIGS. 7 and 8, the ball 16 projects from the outer surface of the driven shaft 12.

As seen from FIGS. 7 and 8, when the three balls 16 are projected from the surface of the spring seat 12B, respectively, by the pressing segment 15A, the flange 11D is extended outwardly in the radial direction by these three balls 16 so that friction force is generated between the balls 16 and the flange 11D. As a result, as seen from FIG. 7, the inter diameter of the coil spring 11 is reduced so that the friction force between the coil spring 11 and the driven shaft 12 is increased. After several tens meters seconds, the coil spring 11 is fastened to the driven shaft 12 so that the driven shaft 12 rotates together with the coil spring 11 and drive shaft 10.

Further, the urging member 15 is rotatably attached to the solenoid driver 14 and coupled with the driven shaft 12 through the balls 16. Therefore, the urging member 15 is rotated together with the driven shaft 12. Now, the driven shaft 12 has the pinion 12C tooth-engaged with the rack 18A of the plunger 18. So, when the driven shaft 12 rotates, the plunger 18 moves toward the tip side of the housing 2.

When the driven shaft 12 is rotated, the rotating energy accumulated in the flywheel 9 as well as the output from the motor 8 is transmitted to the driven shaft 12. For this reason, the driven shaft 12 is rotated abruptly at a high speed in a state coupled with the coil spring 11. Incidentally, simultaneously when the solenoid 13 is driven, power supply to the motor 8 may be stopped.

Meanwhile, when the driving is started, as seen from FIG. 13, the plunger 18 and the driver blade 18B are located at their initial position (uppermost position in FIG. 13) by a return spring not shown and pinion 12C is tooth-engaged with the area A of the rack 18A (lower end portion in FIG. 13).

Thus, when the driven shaft 12 rotates abruptly at a high speed as described above, the pinion 12C also rotates at a high speed. Thus, the plunger 18 having the rack 18A tooth-engaged with the pinion 12C moves abruptly toward the tip of the housing 2 (lower end in FIG. 13). The driver blade 18B attached to the tip of the plunger 18 is extruded in the same direction so that the tip of the driver blade 18B collides with the nail 6 accommodated in the injector 7. As a result, as seen from FIG. 14, by this collision force, the nail 6 is extruded from the injection mouth 7a of the injector 7 is driven into the driven target W such as wood.

Now, the state when the driving has been completed is shown in FIG. 14. When the driving has been completed, the pinion 12C is tooth-engaged with the area B (upper end in FIG. 14) of the rack 18A of the plunger 18. At this time, as shown, the plunger 18 violently collides with the damper 23. The resultant shock is absorbed by the damper 23 so that great shock reaction acts on the area B of the rack 18A on the plunger 18.

According to the inclination of the body of the electric nail driver 1, the balls 16 may project from the slots 12a owing to gravitation. However, since the balls 16 are not supported by the pressing segment 15A, only slight urging force exists so that the flange 11D will not be urged.

When the driving has been completed, energization of the solenoid 13 is completed. So, the solenoid driver 14 moves in the contracting direction by the urging force of the solenoid twisting spring 14A. Since the urging member 15 also moves likewise, the balls 16 are seated on the receiving segment 15B surface. Correspondingly, the friction force between the balls 16 and the flange 11D attached to 11B, the other end of the coil spring 11, is lost. Then, the coil spring 11 is loosened at the area having tightened the spring seat 12B and restored to the internal diameter before the driving is started. Thus, the coupling between the coil spring 11 and the driven shaft 12 is released.

If the coupling of the driven shaft 12 with the coil spring 11 is released after the nail 6 has been driven into the driven target W, the force urging the plunger 18 toward the tip thereof does not act on the plunger 18. Thus, the plunger 18 is pulled back toward the rear end (upper end in FIG. 1) by a return spring (not shown) and restored to the state before the nail 6 is driven in.

Accordingly, by repeating the operation described above, the nail 6 can be successively driven into the driven target W such as wood. Incidentally, after the push lever 25 is previously pressed on the driven target W, the trigger switch 4 may be turned ON (pulled).

In the operation described above, in the electric nail driver 1 according to this embodiment, since the tooth width L1 in an area A of the rack 18A formed on the plunger 18 (area suffering from relatively small shocking reaction) with which the pinion 12C is tooth-engaged when driving is started or being carried out is set to be narrower than tooth width L2 in an area B of the rack 18A with which the pinion 12C is tooth-engaged when the driving is completed (area suffering from relatively large shocking reaction), i.e. L1<L2, the tooth-width of the rack 18A can be set at an appropriate value corresponding to the force acting on the pertinent area. Thus, the plunger 18 can be weight-reduced in such a degree that the tooth width L1 in the area A of the rack is made narrower than the tooth width L2 in the area B of the rack 18A. It should be noted that the tooth width of the rack 18A has been set hitherto at the wide width L2 over the entire length thereof.

Thus, if the plunger 18 is weight-reduced as described above, the plunger 18 can be accelerated faster so that the driving time can be shortened. So, the energy loss due to the friction during the driving can be restrained so that the energy efficiency is enhanced.

Further, the lighter the plunger 18 is, the smaller is the reaction acting on the driver body when the plunger 18 is accelerated. Owing to this, the reaction at the time of driving is restrained so that the operability can be improved.

Further, if the plunger 18 is light, the kinetic energy accumulated in the plunger 18 itself is small. Therefore, the volume of the damper 23 for absorbing the shock due to violent collision by the plunger 18 at the time of driving can be reduced so that it can be downsized.

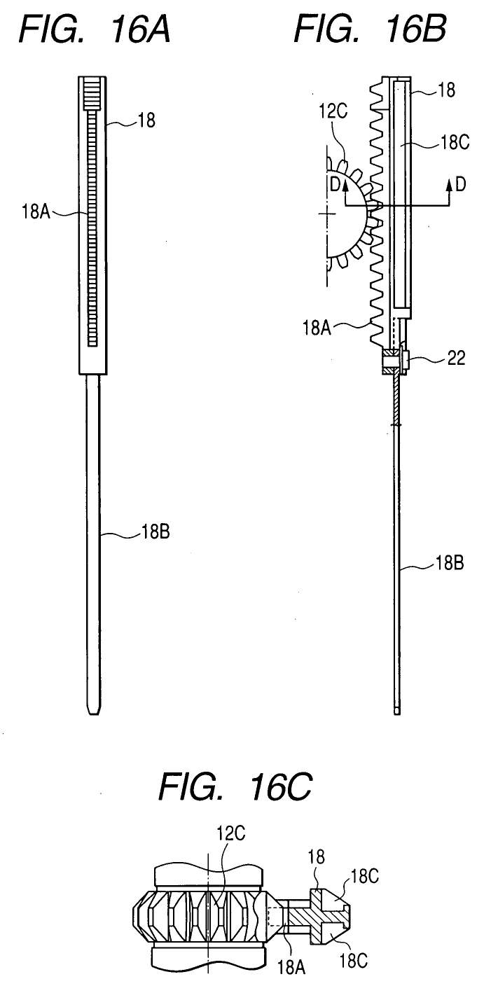

Now, another format of this invention is shown in FIGS. 16(a) to 16(c).

FIG. 16(a) is a front view of a plunger and a driver plate according to this format. FIG. 16(b) is a broken side view of the plunger and the driver plate. FIG. 16(c) is a sectional view taken in line D-D in FIG. 16(b) in which the tooth engagement state between a rack and a pinion. Incidentally, the tooth engagement state between the rack and the pinion is the same in the above embodiment also. On both sides of the plunger 18, as shown, groove-like width-reduced segments 18C are formed along the longitudinal direction of the plunger 18. If the width-reduced segments 18C are formed on both sides of the plunger 18 in this way, the plunger 18 can be further weight-reduced. Owing to the weight reduction, the effect of improving the energy efficiency and restraining the reaction at the time of driving can be further enhanced.

In the above embodiment, as an example of the portable driver, the electric nail driver has been explained. However, this invention can be applied to any other portable driver for driving a screw or a staple other than the nail serving as a fastener.

What is claimed is:

1. A portable driver comprising:
a driver plate for driving a fastener;
a plunger formed integrally to or separately from said driver plate;
a rack formed on said plunger;
a pinion to be tooth-engaged with said rack; and
a driving means for rotatively driving said pinion, wherein the fastener is driven by linearly moving said plunger and said driver plate owing to rotation of said pinion, wherein a tooth width of said rack is changed in a longitudinal direction thereof.

2. A portable driver according to claim 1, wherein said tooth width of said rack is changed in at least two steps.

3. A portable driver according to claim 1, wherein the tooth width L1 in an area A of the rack with which said pinion is tooth-engaged when driving is started or being carried out is narrower than the tooth width L2 in an area B of the rack with which said pinion is tooth-engaged when the driving is completed, i.e. L1<L2.

4. A portable driver according to claim 1, wherein groove-like reduced thickness zones are formed on both sides of said plunger.
